(19) United States
(12) Patent Application Publication
(10) Pub. No.: US 2026/0158448 A1
(43) Pub. Date: Jun. 11, 2026

(54) Bendable Flexible Flat Membrane Module And Method For Manufacturing Same

(71) Applicant: Chang Yong KIM, Siheung-si (KR)

(72) Inventor: Chang Yong KIM, Siheung-si (KR)

(73) Assignee: Ryan Shin, Las Vegas, NV (US)

(21) Appl. No.: 18/976,302

(22) Filed: Dec. 10, 2024

(51) Int. Cl. B01D 63/08; B01D 71/36

(52) U.S. Cl. CPC B01D 63/089; B01D 71/36; B01D 2313/086

(57) ABSTRACT

A bendable flexible flat membrane module that enables a smooth flow of filtered water that has been filtered or washing water for backwashing includes at least two membranes facing each other and constituting both outer surfaces, a support member made of a flexible material and embedded inside the at least two membranes constituting the both outer surfaces; and a plurality of point boding portions formed by pressing and bonding the both outer surfaces facing each other at a predetermined point, wherein the plurality of point bonding portions are formed to be spaced apart at a predetermined distance from each other. A plurality of flow paths are created by the point bonding portions which create a zigzagging flow pattern suitable for filtering and backwashing. A method for manufacturing the bendable flexible flat membrane module is also disclosed.

### CROSS-REFERENCE TO RELATED APPLICATIONS

The present continuation-in-part application claims priority benefit of the U.S. national stage application for patent Ser. No. 16/763,993 titled “Bendable Flexible Flat Membrane Module And Method For Manufacturing Same” filed on May 14, 2020 under 35 U.S.C. § 119(a). The contents of this related continuation-in-part application are incorporated herein by reference for all purposes to the extent that such subject matter is not inconsistent herewith or limiting hereof.

### RELATED CO-PENDING U.S. PATENT APPLICATIONS

Not applicable.

### FEDERALLY SPONSORED RESEARCH OR DEVELOPMENT

Not applicable.

### REFERENCE TO SEQUENCE LISTING, A TABLE, OR A COMPUTER LISTING APPENDIX

Not applicable.

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office, patent file or records, but otherwise reserves all copyright rights whatsoever.

### BACKGROUND OF THE INVENTION

### 1. Field of the Invention

The present invention relates to a bendable flexible flat membrane module and a method of manufacturing the same, and more particularly, to a bendable flexible flat membrane module capable of freely moving and being freely bent by a user's choice by using a flexible material as an inner member, thereby facilitating backwashing and enabling mass production, and a method of manufacturing the same.

### 2. Description of the Related Art

Generally, water purification refers to a process in which turbid water is treated (purified) for the purpose of drinking, industrial use, or agricultural use through self-purification, purification of the earth, or other artificial treatment.

For example, a water supply system is a system supplying water that may be trusted and drank through a water pipe, and the drinking water finally supplied to a user through the water pipe should be purified so as to meet water quality standards. Therefore, when it is possible to obtain high quality raw water close to a target water quality, a simple water treatment may be sufficient. However, water treatment is not easy in a downstream part of a large river in which many cities, factories or agricultural lands are located, and thus a separate water treatment facility should be provided. Presently, there exists a need for an improved bendable flexible flat membrane module capable of freely moving and being freely bent by a user's choice by using a flexible material as an inner member, thereby facilitating backwashing and enabling mass production. Such a system and method must be able to facilitate the easy insertion and removal of an in-ground storage container which prevents foreign objects such as dirt and rocks from entering the underground storage space. Such a system must be able to provide a waterproof container which ensures valuables stored therein will not be damaged during storage. Moreover, such a system must be an affordable alternative to more expensive systems currently known and understood in the art.

### SUMMARY

The present invention fulfils the long-felt need for an improved bendable flexible flat membrane and method of manufacture. At its essence, the invention comprises a bendable flexible flat membrane module that enables a smooth flow of filtered water that has been filtered or washing water for backwashing, comprising at least two membranes facing each other and constituting both outer surfaces; a support member made of a flexible material and embedded inside the membrane constituting the both outer surfaces; and a plurality of point boding portions formed by pressing and bonding the both outer surfaces facing each other at a predetermined point, wherein the plurality of point bonding portions are formed to be spaced apart at a predetermined distance from each other, and a flow path is formed between the plurality of bonding portions.

An object of the present invention is to solve the above described problems and provide a bendable flexible flat membrane module capable of moving filtration water or washing water more smoothly, and a method of manufacturing the same.

Another aspect of the present invention is to provide a bendable flexible flat membrane module capable of improving workability without requiring a support frame and enabling mass production, and a method of manufacturing the same.

Still another aspect of the present invention is to provide a bendable flexible flat membrane module that enables a smooth flow of water during backwashing and a method of manufacturing the same.

Still another aspect of the present invention is to provide a bendable flexible flat membrane module capable of maximizing grease cleaning by air bubbles while deforming a shape of a membrane into a zigzag shape using an operation bar, and a method of manufacturing the same.

In order to achieve the above object, a bendable flexible flat membrane module according to an embodiment of the present invention includes: a membrane facing each other and constituting both outer surfaces; a support member made of a flexible material and embedded inside the membrane constituting the both outer surfaces; and a plurality of point bonding portions formed by pressing and bonding the both outer surfaces facing each other at a predetermined point.

The plurality of point bonding portions are formed to be spaced apart at a predetermined distance from each other. A flow path is formed between the plurality of point bonding portions. A water supply and collection pipe formed of a flexible material, and extending from an upper portion to a lower portion of the flat membrane module to be embedded therein is further included.

A bendable flexible flat membrane module according to another embodiment of the present invention includes: a membrane facing each other and constituting both outer surfaces; a pair of support members made of a flexible material and embedded in the membrane constituting the both outer surfaces; an intermediate member made of a porous material and inserted between the pair of support members; and a plurality of point bonding portions formed by pressing and bonding the both outer surfaces facing each other at a predetermined point.

A method of manufacturing a bendable flexible flat membrane module according to the present invention includes: a step (a) of attaching a support member made of a flexible material to a membrane; a step (b) of contacting a pair of membranes to which the support member is attached so that the support member faces each other; and a step (c) of forming a plurality of point bonding portions on both outer surfaces of the membrane. In the step (a), the support member is bonded to the membrane by a heat lamination method.

A method of bonding the plurality of point bonding portions uses any one of a method of bonding using rivets, a method of bonding using sawing, and a method of bonding using an ultrasonic wave or a heat lamination.

According to the present invention, filtration water or washing water may be moved more smoothly.

In addition, according to the present invention, it is possible to improve the workability without requiring a support frame, and to enable mass production.

Further, according to the present invention, it is possible to smoothly flow water during backwashing, thereby preventing the membrane from swelling.

### BRIEF DESCRIPTION OF THE DRAWINGS

The invention directed by way of example, and not by way of limitation, in the figures of the accompanying drawings and in which like reference numerals refer to similar elements and in which:

FIG. 1 is a perspective view of a filter medium in accordance with the related art;

FIG. 2 is a perspective view illustrating a bendable flexible flat membrane module in accordance with an embodiment of the invention;

FIG. 3 is a cross-sectional view illustrating a manufacturing process of a bendable flexible flat membrane module in accordance with an embodiment of the invention;

FIG. 4 is a cross-sectional view of a bendable flexible flat membrane module in accordance with an embodiment of the invention;

FIG. 5 is a usage state diagram of a bendable flexible flat membrane module in accordance with an embodiment the invention; and

FIG. 6 is a perspective view illustrating a bendable flexible flat membrane module in accordance with an embodiment of the present invention.

Unless otherwise indicated illustrations in the figures are not necessarily drawn to scale.

### DETAILED DESCRIPTION OF THE PREFERRED EMBODIMENTS

Terminology used herein is used for the purpose of describing particular embodiments only, and is not intended to limit the scope of the present invention. It must be understood that as used herein and in the appended claims, the singular forms “a,” “an,” and “the” include the plural reference unless the context clearly dictates otherwise. For example, a reference to “an element” is a reference to one or more elements and includes all equivalents known to those skilled in the art. All conjunctions used are to be understood in the most inclusive sense possible. Thus, the word “or” should be understood as having the definition of a logical “or” rather than that of a logical “exclusive or” unless the context clearly necessitates otherwise. Language that may be construed to express approximation should be so understood unless the context clearly dictates otherwise.

Unless defined otherwise, all technical and scientific terms used herein have the same meanings as commonly understood by a person of ordinary skill in the art to which this invention belongs. Preferred methods, techniques, devices, and materials are described. But any methods, techniques, devices, or materials similar or equivalent to those described herein may be used in the practice or testing of the present invention. Structures described herein should also be understood to refer to functional equivalents of such structures.

References to “one embodiment,” “one variant,” “an embodiment,” “a variant,” “various embodiments,” “numerous variants,” etc., may indicate that the embodiment(s) of the invention so described may include particular features, structures, or characteristics. However, not every embodiment or variant necessarily includes the particular features, structures, or characteristics. Further, repeated use of the phrase “in one embodiment,” or “in an exemplary embodiment,” or “a variant,” or “another variant,” do not necessarily refer to the same embodiment although they may. A description of an embodiment with several components in communication with each other does not imply that all such components are required. On the contrary, a variety of optional components are described to illustrate the wide variety of possible embodiments and/or variants of the present invention.

As is well known to those skilled in the art, many careful considerations and compromises typically must be made when designing the optimal manufacture or commercial implementation of such an underground storage system and method. A commercial implementation in accordance with the spirit and teachings of the invention may be configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art.

The exemplary underground storage system and method will now be described in detail with reference to embodiments thereof as illustrated in the accompanying drawings.

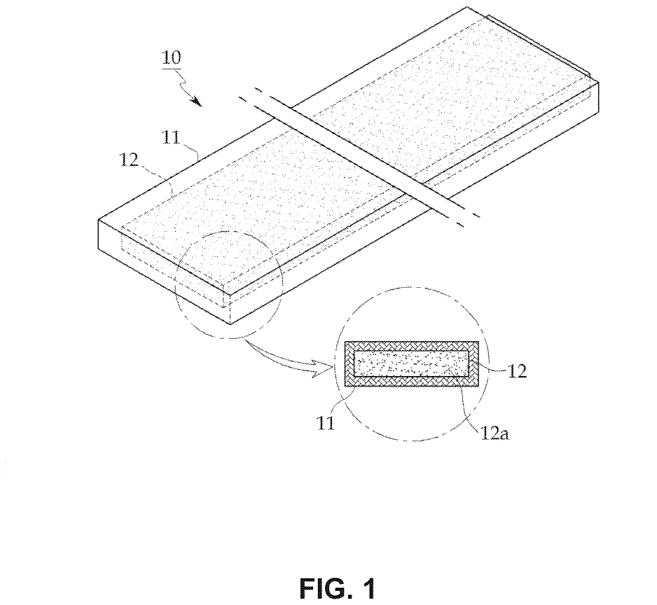

FIG. 1 is a perspective view of a filter medium in accordance with the prior and related art. In the related art, the water to be filtered is described without distinction, but it should be noted that it may be applied to both a water purification device for filtering clean water and a sewage treatment device for filtering sewage at a sewage treatment plant.

As shown in FIG. 1, a filter medium 10 according to the related art includes a membrane 11 and an inner member 12 bonded to an inner surface of the membrane 11.

The membrane 11 is formed of a polytetrafluoroethylene (PTFE) membrane or a polymer membrane, which is a very stable compound due to strong chemical bonding between fluorine and carbon among fluorine resins performing a surface filtration function.

Thereamong, the PTFE membrane has properties such as almost complete chemical inertness, heat resistance, non-tackiness, excellent insulation stability, and low coefficient of friction. Preferably, a pore size of the membrane 11 ranges from several tens of micrometers to 0.001 μm depending on characteristics of the water purification device, and a thickness of the membrane 11 is about 10 μm.

However, in a conventional filter, since the inner member 12 is formed of a rigid material and the membrane 11 is bonded to the inner member 12, there is a problem in that it is difficult to effectively remove foreign matters sticking to an outer surface of the membrane 11. Generally, backwashing should be performed to remove foreign matters, which makes it difficult for washing water to pass through the pores of the membrane 11 during backwashing, so that there is a problem is that the membrane 11 is swollen.

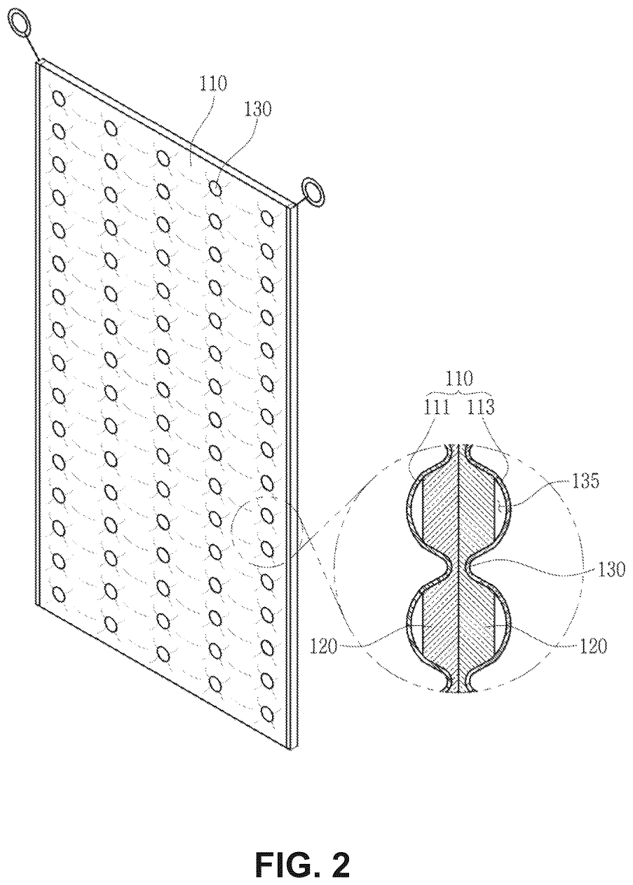

FIG. 2 is a perspective view illustrating a bendable flexible flat membrane module in accordance with an embodiment of the invention. In one embodiment, the bendable flexible flat membrane module according to the present invention includes a membrane 110 facing each other and constituting both outer surfaces, and a support member 120 of a flexible material embedded in the membrane 110 constituting both outer surfaces 111 and 113.

In one embodiment, a bendable flexible flat membrane module that enables a smooth flow of filtered water comprises at least two outer PTFE membranes 110; at least one support member 120 made of a flexible material attached to each outer PTFE membrane; and a plurality of point bonding portions 130 formed by pressing and bonding the at least two outer PTFE membranes and support members at regularly spaced intervals.

The membrane 110 uses a polytetrafluoroethylene (PTFE) membrane or a polymer membrane, which is a very stable compound due to strong chemical bonding between fluorine and carbon among fluorine resins performing a surface filtration function.

The support member 120 is made of a flexible material may be a flexible non-woven material.

In addition, the membrane flat membrane module 100 according to the present invention includes a plurality of point bonding portions 130 on the both outer surfaces 111 and 113.

The point bonding portion 130 is formed by pressing and bonding the both outer surfaces 111 and 113 facing each other at a predetermined point.

As the bonding method, various methods may be used, and for example, a bonding method such as a method by coupling means such as a rivet, a sawing method, or a method by an ultrasonic wave or a heat lamination may be used.

In addition, the plurality of point bonding portions 130 may be formed to be spaced apart at a predetermined distance from each other, and are formed by physically pressing and bonding the both outer surfaces 111 and 113.

When the plurality of point bonding portions 130 are formed as described above, as the outer surfaces 111 and 113 of the membrane 110 are pressed by the point bonding portions 130, a plurality of flow paths 135 are formed between each of the point bonding portions 130. Therefore, filtration water or washing water may smoothly move via the pores of the support member 120 and the flow paths 135. The plurality of flow paths are created by the point bonding portions which create a zigzagging flow pattern suitable for filtering and backwashing.

The edges of the outer surfaces 111 and 113 can be bonded together by numerous methods including, but not limited to sewing, riveting, heat lamination and through the use of adhesives. Such bonding creates a uniform filter membrane module.

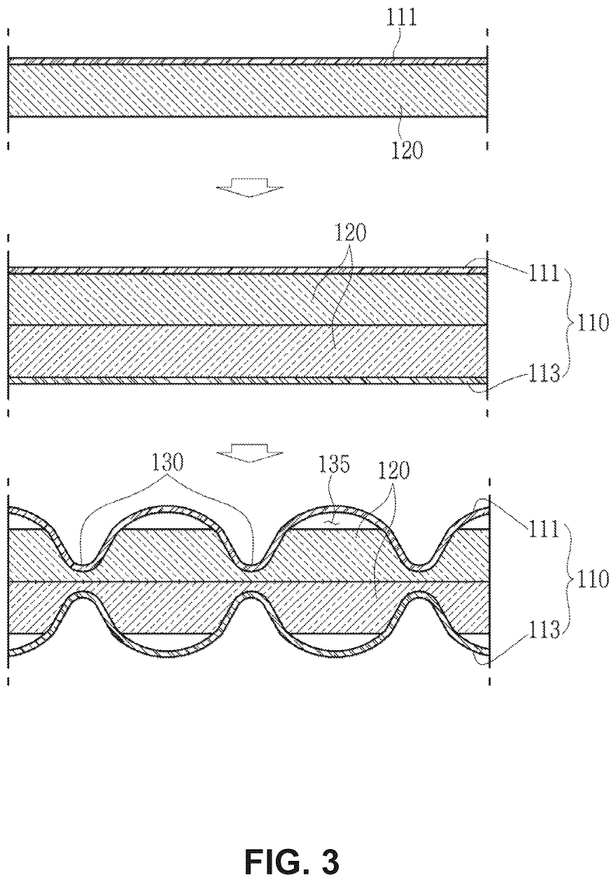

FIG. 3 is a cross-sectional view illustrating a manufacturing process of a bendable flexible flat membrane module in accordance with an embodiment of the invention. The support member 120 made of a flexible material is attached to the membrane 110.

The support member 120 made of a flexible material may be a flexible non-woven material. In this case, the support member 120 may be made of a flexible synthetic resin material such as foamable polypropylene or foamable polyethylene, and a plurality of pores are formed therein. Front, rear, left, right, and lower surfaces of the support member 120 are formed to be surrounded by the membrane 110. In addition, since a melting point of the support member 120 is about 160° C., which is lower than that of the membrane 110 and about 260° C., when the support member 120 is heated to 160° C. or higher, as the surface melts, the support member 120 is laminated to the membrane 110.

Although the support member 120 is described as being bonded to the membrane 110 by a heat lamination method, the present invention is not limited thereto. For example, in the present invention, the support member 120 and the membrane 110 may be bonded to each other in a bonding manner by applying an adhesive in the form of a dot or a mesh to an outer surface of the support member 120 and/or an inner surface of the membrane 110.

The membrane flat membrane module 100 fabricated by laminating the membrane 110 and the support member 120 therein is formed into the form of a thin and long flexible fabric.

In one method of manufacturing, a step (a) of attaching a first support member made of a first flexible material made of a flexible synthetic resin material having a plurality of pores therein to a first PTFE membrane to prepare a first half membrane.

Next, a step (a-1) of attaching a second support member made of a second flexible material made of a flexible synthetic resin material having a plurality of pores therein to a second PTFE membrane to prepare a second half membrane.

(b) The pair of membranes 110 to which the support members 120 are attached are brought into contact so that the support members face each other.

The support member 120 functions as a flow path through which water filtered by passing through the membrane 110 moves via pores therein.

(c) A plurality of point bonding portions are formed on both outer surfaces of the membrane 110.

The point bonding portion 130 is formed by pressing and bonding the both outer surfaces 111 and 113 facing each other at a predetermined point.

As the bonding method, various methods may be used, and for example, a bonding method such as a method by coupling means such as a rivet, a sawing method, or a method by an ultrasonic wave or a heat lamination may be used.

In addition, the plurality of point bonding portions 130 may be formed to be spaced apart from each other at a predetermined distance, and are formed by physically pressing and bonding the both outer surfaces 111 and 113. Such a bond can be created by the melting point differences between the outer surfaces and the support member.

As described above, in the membrane flat membrane module 100 according to the present invention, the support member 120 is embedded in the membrane 110, and the plurality of point bonding portions 130 as described above are provided, thereby forming the plurality of flow paths 135. The flow paths may distend and contort with differing water pressures and volumes as water travels through the membrane module. Such a flow path allows for variable volumes and pressures as the flow paths are bendable and flexible.

In addition, the membrane flat membrane module 100 according to the present invention is made of a flexible material, so the membrane flat membrane module 100 may move freely, and may be bent freely, thereby facilitating backwashing and enabling mass production.

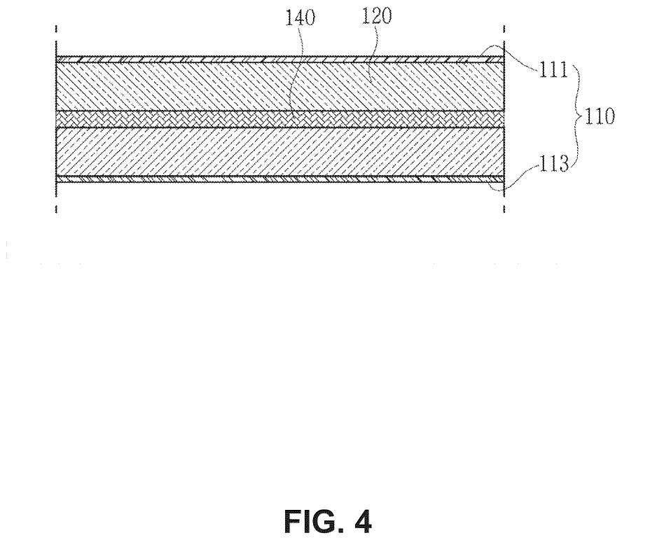

FIG. 4 is a cross-sectional view of a bendable flexible flat membrane module in accordance with an embodiment of the invention. The bendable flexible flat membrane module according to another embodiment of the present invention is the same as the construction and manufacturing method of the bendable flexible flat membrane module 100 according to an embodiment of the present invention, except for additionally embedding an intermediate member 140 made of a porous material in a coupled body between the pair of membranes 110 and the support member 120.

That is, the intermediate member 140 made of the porous material is further embedded in the bendable flexible flat membrane module according to another embodiment of the present invention, thereby further increasing an amount of water flowing inside the membrane flat membrane module.

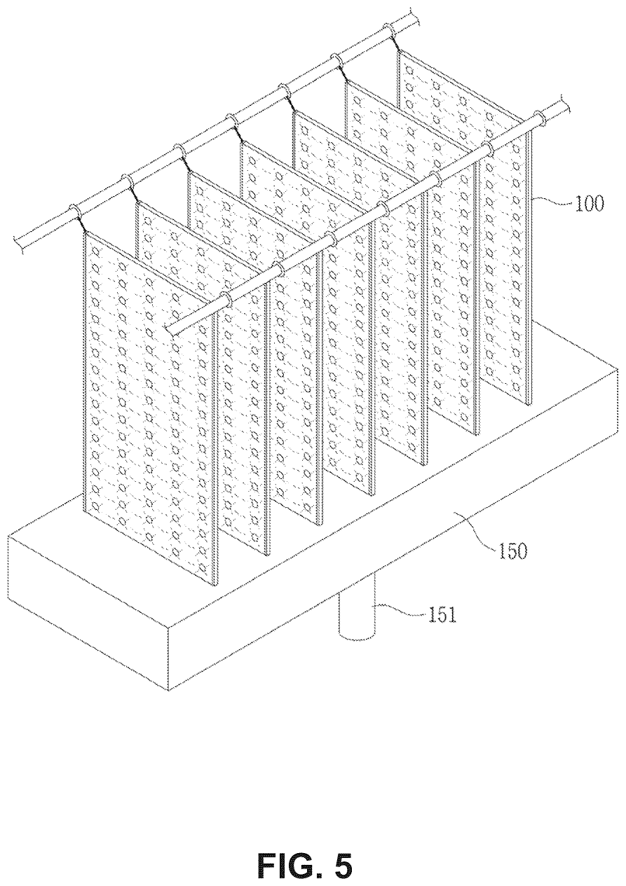

FIG. 5 is a usage state diagram of a bendable flexible flat membrane module in accordance with an embodiment of the invention. The bendable flexible flat membrane module 100 according to the present invention may be inserted into and installed in a housing 150 to perform water purification and filtration.

The water filtered by passing through the membrane flat membrane module 100 may be discharged through an inlet/outlet 151 via the housing 150, and at the time of backwashing, the water introduced via the inlet/outlet 151 may be flowed toward the membrane flat membrane module 100, so that the membrane may be washed.

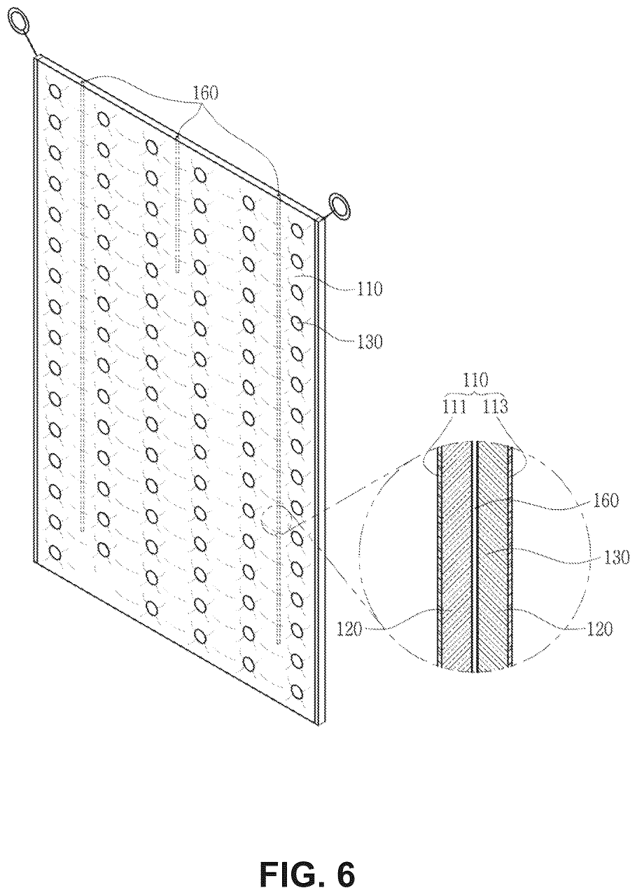

FIG. 6 is a perspective view illustrating a flexible flat membrane module in accordance with an embodiment of the present invention. the membrane flat membrane module according to another embodiment of the present invention, a separate water supply and collection pipe 160 may extend from an upper portion to a lower portion to be embedded therein. The water supply and collection pipe 160 may be preferably made of a flexible material so as to be bent freely.

The water supply and collection pipe 160 is provided to prevent water supply or water collection that is performed toward a lower portion of the membrane flat membrane module from not being performed smoothly due to being far from a water supply unit or a collection unit, and water may be easily supplied or collected downwardly.

All the features disclosed in this specification, including any accompanying abstract and drawings, may be replaced by alternative features serving the same, equivalent or similar purpose, unless expressly stated otherwise. Thus, unless expressly stated otherwise, each feature disclosed is one example only of a generic series of equivalent or similar features.

Having fully described at least one embodiment of the bendable flexible flat membrane module and method for manufacturing same, other equivalent or alternative methods of implementing the underground storage system and method according to the present invention will be apparent to those skilled in the art. Various aspects of the invention have been described above by way of illustration, and the specific embodiments disclosed are not intended to limit the invention to the particular forms disclosed. The particular implementation of the bendable flexible flat membrane module and method for manufacturing same may vary depending upon the particular context or application. By way of example, and not limitation, the bendable flexible flat membrane module and method for manufacturing same described in the foregoing was principally directed to medium scale filtering operations. However, similar techniques may instead be applied to larger or smaller filter membrane systems which implementations of the present invention are contemplated as within the scope of the present invention. Furthermore, implementations of the invention may extend to greater lengths and widths depending on need. The invention is thus to cover all modifications, equivalents, and alternatives falling within the spirit and scope of the following claims. It is to be further understood that not all of the disclosed embodiments in the foregoing specification will necessarily satisfy or achieve each of the objects, advantages, or improvements described in the foregoing specification.

Although specific features of the bendable flexible flat membrane module and method for manufacturing same are shown in some drawings and not others, persons skilled in the art will understand that this is for convenience. Each feature may be combined with any or all of the other features in accordance with the invention. The words “including,” “comprising,” “having,” and “with” as used herein are to be interpreted broadly and comprehensively, and are not limited to any physical interconnection. Claim elements and steps herein may have been numbered and/or lettered solely as an aid in readability and understanding. Any such numbering and lettering in itself is not intended to and should not be taken to indicate the ordering of elements and/or steps in the claims to be added at a later date.

Any amendment presented during the prosecution of the application for this patent is not a disclaimer of any claim element presented in the description or claims to be filed. Persons skilled in the art cannot reasonably be expected to draft a claim that would literally encompass each and every equivalent.

What is claimed is:

1. A bendable flexible flat membrane module that enables a smooth flow of filtered water that has been filtered or washing water for backwashing, comprising
a. at least two membranes facing each other and constituting both outer surfaces;
b. a support member made of a flexible material and embedded inside the at least two membranes constituting the both outer surfaces; and
c. a plurality of point boding portions formed by pressing and bonding the both outer surfaces facing each other at a predetermined point, wherein the plurality of point bonding portions are formed to be spaced apart at a predetermined distance from each other.

2. The bendable flexible flat membrane of claim 1 wherein a plurality of flow paths for filtered water are formed between the plurality of bonding portions.

3. The bendable flexible flat membrane of claim 2 wherein the plurality of flow paths are in a zigzag pattern.

4. The bendable flexible flat membrane of claim 1 wherein the support member is made from foam polyethylene.

5. The bendable flexible flat membrane of claim 1 wherein the support member is made from foam polypropylene.

6. The bendable flexible flat membrane of claim 1 wherein the at least two membranes facing each other and constituting both outer surfaces are made from PTFE.

7. The bendable flexible flat membrane module of claim 1 wherein the membrane module can be inserted into a housing to perform water purification and filtration.

8. The bendable flexible flat membrane module of claim 1 wherein a water supply and collection pipe can be embedded into the membrane module.

9. A bendable flexible flat membrane module that enables a smooth flow of filtered water comprising;
a. at least two outer PTFE membranes;
b. at least one support member made of a flexible material attached to each outer PTFE membrane; and
c. a plurality of point bonding portions formed by pressing and bonding the at least two outer PTFE membranes and support members at regularly spaced intervals.

10. The bendable flexible flat membrane of claim 1 wherein a flow path for filtered water is formed between the plurality of bonding portions.

11. The bendable flexible flat membrane of claim 2 wherein the flow path is a zigzag pattern.

12. The bendable flexible flat membrane of claim 1 wherein the support member is made from foam polyethylene.

13. The bendable flexible flat membrane of claim 1 wherein the support member is made from foam polypropylene.

14. The bendable flexible flat membrane module of claim 1 wherein the membrane module can be inserted into a housing to perform water purification and filtration.

15. A bendable flexible flat membrane module that enables a smooth flow of filtered water that has been filtered or washing water for backwashing, comprising:
a. a first half membrane including a support member made of a first flexible material made of a flexible synthetic resin material having a plurality of pores therein and a first PTFE membrane;
b. a second half membrane including a support member made of a second flexible material made of a flexible synthetic resin material having a plurality of pores and a second PTFE membrane; and
c. a plurality of point boding portions formed by pressing and bonding the both outer surfaces facing each other at a predetermined point, wherein the plurality of point bonding portions are formed to be spaced apart at a predetermined distance from each other.

16. The bendable flexible flat membrane of claim 1 wherein a flow path for filtered water is formed between the plurality of bonding portions.

17. The bendable flexible flat membrane of claim 2 wherein the flow path is a zigzag pattern.

18. The bendable flexible flat membrane of claim 1 wherein the support member is made from foam polyethylene.

19. The bendable flexible flat membrane of claim 1 wherein the support member is made from foam polypropylene.

20. The bendable flexible flat membrane module of claim 1 wherein the membrane module can be inserted into a housing to perform water purification and filtration.
